(19) United States
(12) Patent Application Publication
(10) Pub. No.: US 2011/0148759 A1
(43) Pub. Date: Jun. 23, 2011

(54) POINTING DEVICE WITH TILT-ADJUSTING FUNCTION AND ASSOCIATED CONTROLLING METHOD

(75) Inventors: Ying-Ming Hwang, Taipei (TW); Tzung-Lin Lee, Taipei (TW); Feng-Chang Hsu, Taipei (TW)

(73) Assignee: AVerMedia Information, Inc., Taipei (TW)

(21) Appl. No.: 12/973,080

(22) Filed: Dec. 20, 2010

(30) Foreign Application Priority Data
Dec. 22, 2009 (TW) 098144302

(51) Int. Cl. G09G 5/08

(52) U.S. Cl. 345/157

(57) ABSTRACT

A pointing device cooperates with a display device which shows a cursor moving in response to a movement of the pointing device. The pointing device includes a casing, a sensing unit and a modulation structure. The sensing unit senses a first movement of the pointing device to acquire first movement information when the sensing unit is arranged in a first position. The modulation structure connected with the sensing unit adjusts the sensing unit from the first position to a second position. Then, the sensing unit senses the first movement of the pointing device to acquire second movement information when the sensing unit is arranged in the second position. The moving path of the cursor is shown on the display device according to the first movement information or the second movement information.

### FIELD OF THE INVENTION

The present invention relates to a pointing device with tilt-adjusting function and associated controlling method, and more particularly to a pointing device which corrects display tilt by transforming movement information outputted by the pointing device and associated controlling method.

### BACKGROUND OF THE INVENTION

In a computer system, a pointing device such as a mouse or a pen mouse is used for controlling a cursor shown on a display device. It is easy to use such pointing device to select or point to an object on the display device. However, the performance of the pointing device in drawing or writing is usually unsatisfied because the operation of the pointing device should meet a strict precision requirement. Since the hand-eye coordination and manipulating habit of different users are different, the holding angle of the pointing device for different users also varies. In other words, the cursor-moving path shown on the display device is different from the moving path expected by the user.

When a pen is used to write or draw on a paper sheet, the tip contact surface and the paper sheet are coplanar. On the other hand, when the pointing device (e.g. a mouse or a pen mouse) is used to control the cursor moving on the display device, the surface supporting the pointing device and the display device are not coplanar. That is, the movement of the pointing device is not exact the cursor movement. As such, it is necessary for the user to correlate the movement of the pointing device with the cursor movement. However, it is apparent that the results of correlation are different among different users.

Hereinafter, the deviation between the real image drawn via a pointing device and the ideal image will be illustrated with reference to FIG. 1. FIG. 1A is a schematic diagram illustrating an ideal image which should be shown on the display device. Ideally, the tree 101 drawn via a pointing device and shown on the display device should be upright. Since it is almost impossible for the user to always write or draw in an absolutely “correct” direction, the tree 101 shown on the display device is deviated from the reference coordinate system of the display device. That is, as shown in FIG. 1B, the user basis (e.g. x′-y′ coordinate system) shown on the display device is deviated from the standard basis (i.e. the x-y coordinate system) of the display device by a deviation angle θ. In other words, the real image tilts. For different users and different pointing devices, the deviation angle θ varies. For example, there is a deviation angle θ1 between the user basis and the standard basis for a user A; but there is another deviation angle θ2 between the user basis and the standard basis for a user B.

Generally, the deviation angle between the user basis and the standard basis is manually corrected. The manual correcting method is neither user-friendly nor ergonomic. Otherwise, to prevent the deviation or tilt, the user may use a drawing tablet. By referring to the edge of the drawing tablet, it becomes easier to draw or write in a precise direction to meet the standard basis. Although the use of the drawing tablet may correct the deviation or tilt, there are still some drawbacks. For example, since the size of the drawing tablet is much bulkier than the ordinary pointing device, the use of the drawing tablet is inconvenient.

From the above discussions, the conventional method for correcting the deviation angle between the user basis and the standard basis is usually unsatisfied. Although the use of the drawing tablet may correct the deviation angle, another problem occurs. Therefore, there is a need of providing a device for correcting the deviation angle.

### SUMMARY OF THE INVENTION

In accordance with an aspect, a pointing device with tilt-adjusting function cooperating with a display device is provided. The pointing device includes a casing, a sensing unit disposed in the casing and a modulation structure disposed on the casing. The sensing unit senses a first movement of the pointing device to acquire first movement information when the sensing unit is arranged in a first position. The sensing unit also senses the first movement of the pointing device to acquire second movement information when the sensing unit is arranged in a second position. The modulation structure is connected with the sensing unit for adjusting the sensing unit from the first position to the second position.

In accordance with another aspect, a display system including a pointing device and a display device is provided. The pointing device includes a casing, a sensing unit disposed in the casing and a modulation structure disposed on the casing. The sensing unit senses a first movement of the pointing device to acquire first movement information when the sensing unit is arranged in a first position. The sensing unit also senses the first movement of the pointing device to acquire second movement information when the sensing unit is arranged in a second position. The modulation structure is connected with the sensing unit for adjusting the sensing unit from the first position to the second position. The display device displays a cursor moving along a first moving path and a second moving path corresponding to the first movement information and the second movement information, respectively.

In accordance with an aspect, a controlling method of a pointing device is provided. The pointing device includes a sensing unit and a modulation structure. The sensing unit senses a first movement of the pointing device to acquire first movement information when the sensing unit is arranged in a first position. Then, the sensing unit is adjusted from the first position to a second position through the modulation structure. The sensing unit further senses the first movement to acquire second movement information when the sensing unit is arranged in the second position.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A is a schematic diagram illustrating an ideal image which should be shown on a display device;

FIG. 1B is a schematic diagram illustrating a real image shown on the display device;

FIG. 2 is a schematic diagram illustrating a concept of adjusting a user basis (x′-y′ coordinate system) of the pointing device to be more consistent with a standard basis (x-y coordinate system) of the display device according to the present invention;

FIG. 3 is a schematic functional block diagram illustrating a display system according to an embodiment of the present invention;

FIG. 4A is a schematic functional block diagram illustrating the internal configurations of the pointing device wherein the sensing unit is in a first position;

FIG. 4B is a schematic diagram illustrating the moving path shown on the display device when the sensing unit is in the first position;

FIG. 4C is a schematic functional block diagram illustrating the internal configurations of the pointing device after the sensing unit is adjusted to a second position through the modulation structure;

FIG. 4D is a schematic diagram illustrating the moving path shown on the display device after the sensing unit is adjusted to the second position;

FIG. 5 is a flowchart of a controlling method of the pointing device according to the present invention; and

FIGS. 6A and 6B are schematic cutaway diagrams illustrating the internal configurations of the pen mouse according to the present invention.

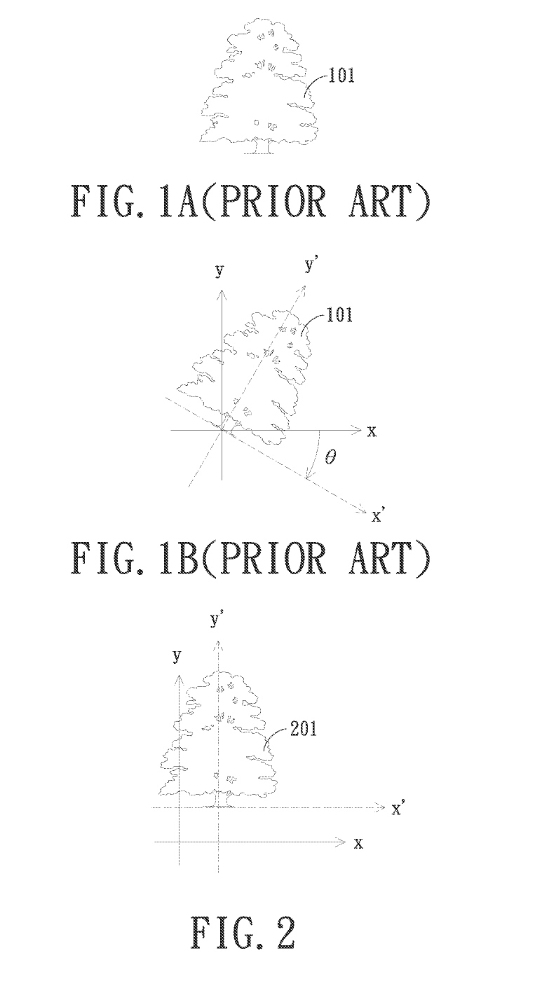

### DETAILED DESCRIPTION OF THE PREFERRED EMBODIMENT

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

As previously described in the prior art, when the moving path of the pointing device is shown on the display device, a tilt usually occurs. For obviating the drawbacks encountered in the prior art, the present invention provides a pointing device for use with a display device (e.g. a screen or a tablet computer). The pointing device may be an optical mouse, a mechanical mouse, a pen mouse, a trackball or other known pointing device. In accordance with a key feature of the present invention, a modulation structure is provided for adjusting the physical position of a sensing unit. After the position of the sensing unit is adjusted, the result of sensing the movement of the pointing device will be changed, so that the movement information transmitted from the pointing device to the display device is also changed. According to the change of the movement information, the display deviation or tilt will be effectively corrected.

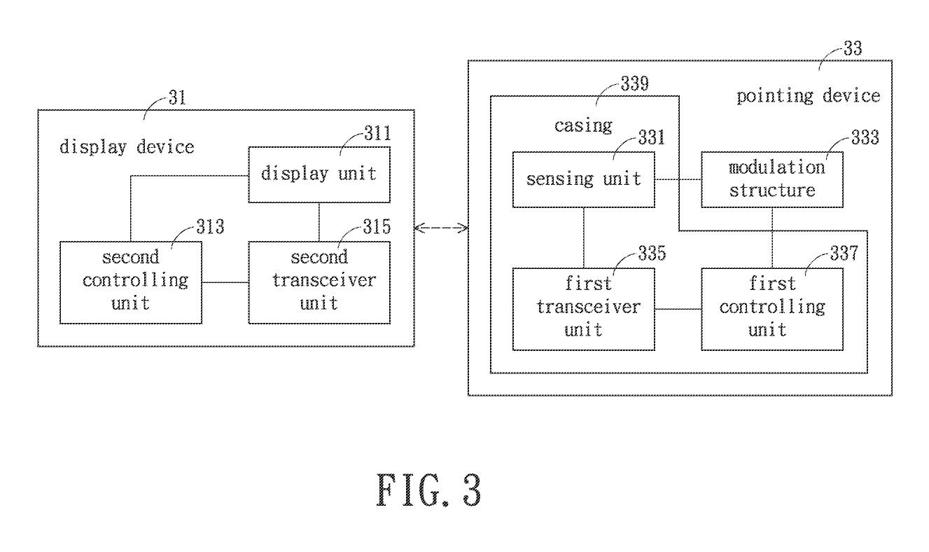

FIG. 2 is a schematic diagram illustrating the user basis (x′-y′ coordinate system) of the pointing device in a more consistent manner with the standard basis (x-y coordinate system) of the display device according to the present invention. The present invention provides a controlling method for adjusting the sensing unit of the pointing device through a modulation structure so that the user basis (x′-y′ coordinate system) is adjusted to be more consistent with the standard basis (x-y coordinate system).

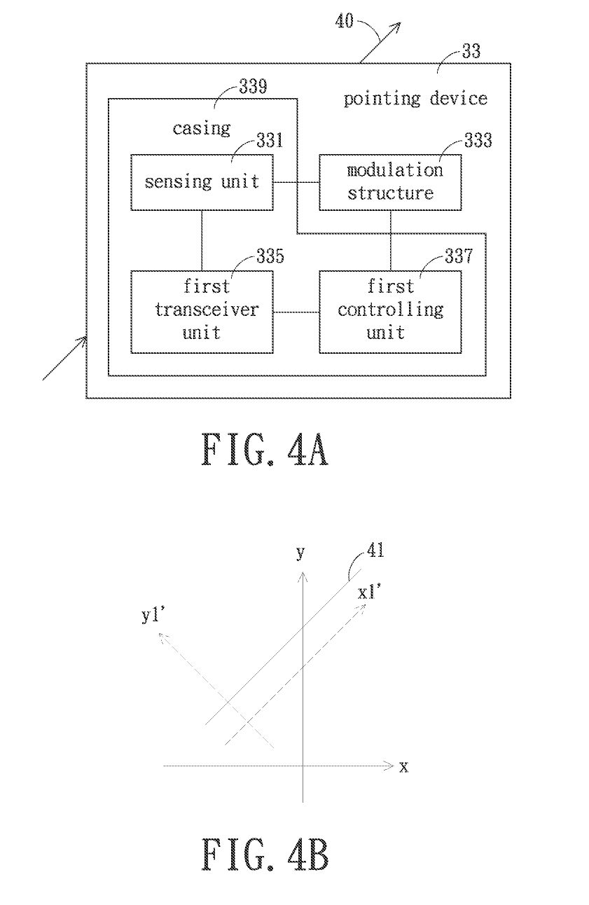

FIG. 3 is a schematic functional block diagram illustrating a display system according to an embodiment of the present invention. The display system includes a display device 31 and a pointing device 33. The display device 31 and the pointing device 33 are in communication with each other according to a wireless transmission technology (e.g. IR, Bluetooth or wireless network) or a wired transmission technology (e.g. data line or cable line).

The pointing device 33 includes a sensing unit 331, a first transceiver unit 335, a first controlling unit 337 and a modulation structure 333. The sensing unit 331 is originally in a first position for sensing a first movement of the pointing device 33, thereby acquiring first movement information. The first transceiver unit 335 is electrically connected with the sensing unit 331 and in communication with the display device 31. Through the first transceiver unit 335, the first movement information acquired by operating the pointing device 33 will be transmitted to the display device 31. The modulation structure 333 is connected with the sensing unit 331. Through the modulation structure 333, the sensing unit 331 is adjusted from the initial first position to a second position. When the sensing unit 331 is in the second position, the first movement of the pointing device 33 is sensed to acquire second movement information. Through the first transceiver unit 335, the second movement information is transmitted to the display device 31. Moreover, the pointing device 33 may also have a casing 339. The sensing unit 331, the first transceiver unit 335, the first controlling unit 337 and other internal components are disposed in the casing 339.

The modulation structure 333, which is connected with the sensing unit 331 for adjusting the position of the sensing unit 331, is a core component of the pointing device 33. Since the sensing unit 331 is adjusted from the first position to the second position through the modulation structure 333, the user basis is changed. When the sensing unit 331 is in the second position, the first movement of the pointing device 33 is sensed to acquire the second movement information. Then, the second movement information is transmitted to the display device 31 through the first transceiver unit 335. Moreover, the modulation structure 333 may be connected with the first controlling unit 337. The first controlling unit 337 is used for controlling the modulation structure 333 to adjust the sensing unit 331.

Depending on the shape, the structure or other factors of the pointing device 33, the way of adjusting the sensing unit 331 through the modulation structure 333 is varied. In some embodiments, the modulation structure 333 includes a sliding part and a rotating mechanism. The sliding part and the rotating mechanism are linked with each other, and the rotating mechanism is further linked to the sensing unit 331. By moving the sliding part, the rotating mechanism is correspondingly driven to adjust the sensing unit 331 from the first position to the second position.

The display device 31 cooperating with the pointing device 33 includes a second transceiver unit 315, a display unit 311 and a second controlling unit 313. The second transceiver unit 315 is in communication with the first transceiver unit 335 of the pointing device 33 for receiving the first movement information and the second movement information from the first transceiver unit 335. The display device 31 is electrically connected with the second transceiver unit 315 for displaying an image according to the first movement information or the second movement information. The second controlling unit 313 is electrically connected with the display unit 311 and the second transceiver unit 315 for extracting the first movement information and the second movement information, thereby obtaining corresponding coordinate values and issuing corresponding control signals. In response to the control signals, a first moving path corresponding to the first movement information and a second moving path corresponding to the second movement information are respectively shown on the display unit 311. The second moving path complies with a new user basis which is more consistent with the standard basis (x-y coordinate system) of the display device 31.

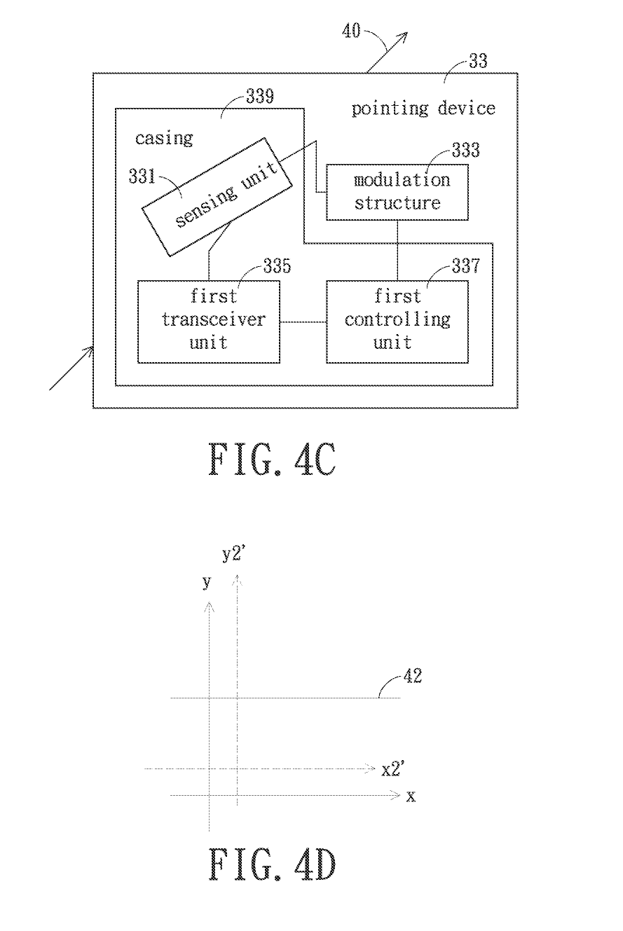

Hereinafter, the internal configurations and the moving paths shown on the display device 31 before and after the sensing unit 311 is adjusted will be illustrated with reference to FIG. 4. FIG. 4A is a schematic functional block diagram illustrating the internal configurations of the pointing device wherein the sensing unit is in the first position. FIG. 4B is a schematic diagram illustrating the moving path shown on the display device when the sensing unit is in the first position. FIG. 4C is a schematic functional block diagram illustrating the internal configurations of the pointing device after the sensing unit is adjusted to the second position through the modulation structure. FIG. 4D is a schematic diagram illustrating the moving path shown on the display device after the sensing unit is adjusted to the second position through the modulation structure.

As shown in FIGS. 4A and 4C, the pointing device 33 is moved along the direction indicated by the arrow, i.e. the first movement. After the position of the sensing unit 331 within the casing 339 is adjusted through the modulation structure 333, the sensing reference of the sensing unit 331 is adjusted to be more consistent with the moving direction of the casing 339. As such, the signal transmitted to the display device 31 is modulated. In addition, the first moving path 41 in FIG. 4B complies with a first user basis, and the second moving path 42 in FIG. 4D complies with a second user basis, wherein the second user basis is more consistent with the standard basis of the display device 31 than the first user basis.

Please refer to FIGS. 4A and 4B again. In response to the first movement of the pointing device 33 before the sensing reference is adjusted, the cursor-moving path is shown according to the first user basis (i.e. x1′-y1′ coordinate system). The x1′-y1′ coordinate system is deviated from the standard basis (i.e. the x-y coordinate system) by a deviation angle θ. By adjusting the angle or the position of the sensing unit 331, the deviation angle θ and the display tilt phenomenon can be offset. In other words, after the sensing unit 331 is adjusted to the second position, the cursor-moving path is shown according to the second user basis (i.e. the x2′-y2′ coordinate system) in response to the first movement of the pointing device 33 (see FIGS. 4C and 4D). As shown in FIG. 4D, the second user basis is more consistent with the standard basis, thereby achieving the purpose of adjusting the display tilt phenomenon.

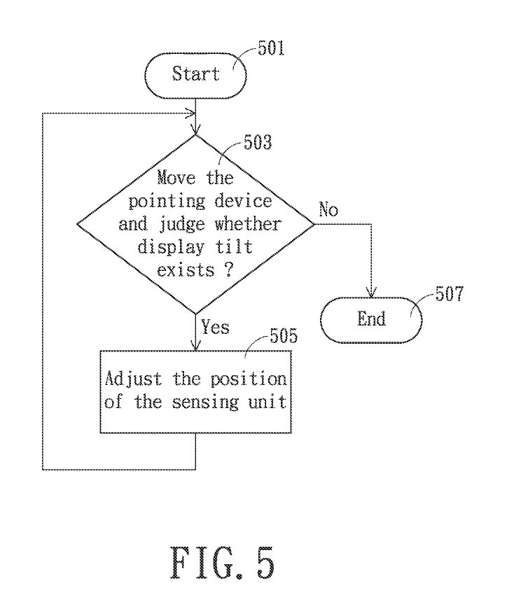

FIG. 5 is a flowchart of a controlling method of the pointing device cooperating with the display device according to the present invention. After the user starts to move the pointing device 33 (Step 501), a moving path in response to the movement of the pointing device 33 is shown on the display unit 311 of the display device 31. Then, the moving path is compared with the standard basis of the display device 31 to realize whether there is a deviation angle between the user basis and the standard basis, i.e. display tilt (Step 503). If display tilt exists, the sensing unit 331 is adjusted and thus the user basis is changed (Step 505). Then, Step 503 and Step 505 repeat until there is no deviation angle between the user basis and the standard basis. If there is no deviation angle between the user basis and the standard basis, it means that the display tilt is corrected and thus the controlling method is finished.

According to the present invention, there are many approaches of adjusting the position of the sensing unit 331 to adjust the deviation between the user basis and the standard basis (in Step 505). Some of the approaches are illustrated in the following description.

A first approach is to adjust the position of the sensing unit 331 connected with the modulation structure 333 by manually manipulating (e.g. rotating or moving) the modulation structure 333 of the pointing device 33. Thus, the movement information in response to the movement of the pointing device 33 is changed. According to the movement information, the user may visually determine whether there is a deviation angle between the user basis and the standard basis. If display tilt exists, the step of adjusting the sensing unit 331 is repeated till there is no deviation angle between the user basis and the standard basis by visual determination.

A second approach uses a training program executed in the display device 31 to adjust the sensing unit 331. Before the pointing device 33 is used to draw or handwrite, the user may draw a test horizontal line or a test vertical line. According to the tilt degree of the test line, the training program may instruct the user how to adjust the sensing unit 331 through the modulation structure 333. For example, the training program may specify the moving/rotating direction or the moving/rotating degree of the sensing unit 331. Graduation may be marked on the pointing device 33 to assist the adjustment.

The modulation structure 333 of the pointing device 33 may include a motor (not shown). The motor is electrically connected to the sensing unit 331. The motor may rotate or move the sensing unit 331 to the second position. The extent of adjusting the sensing unit 331 through the motor may be manually controlled. Alternatively, the motor is connected with the first controlling unit 337 for receiving a control signal issued from the first controlling unit 337. After the adjusting instruction is transmitted from the display device 31 and received by the first transceiver unit 335, the motor is controlled by the first controlling unit 337 to adjust the position of the sensing unit 331 according to the adjusting instruction.

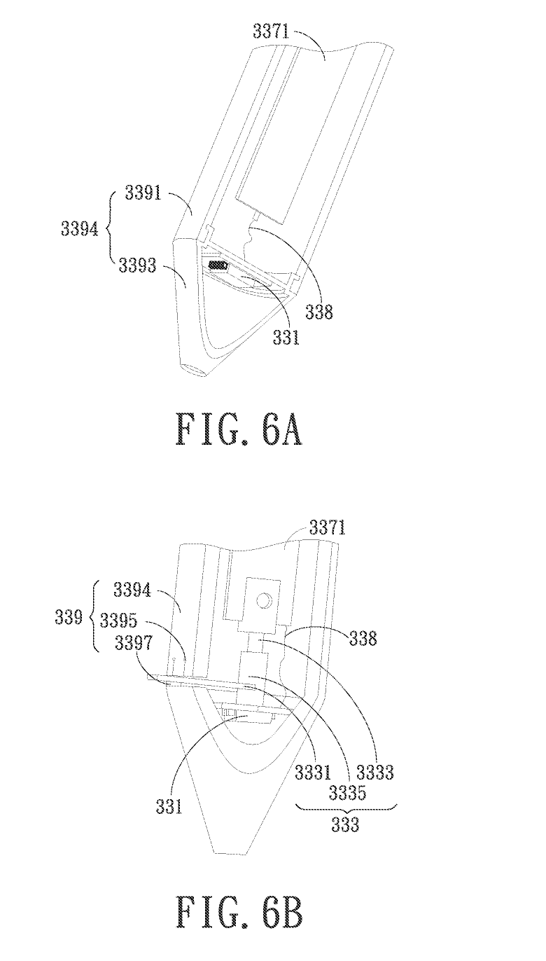

Hereinafter, the internal configurations of a pointing device will be illustrated by referring to a pen mouse. FIGS. 6A and 6B are schematic cutaway diagrams illustrating the internal configurations of a pen mouse according to the present invention. As shown in FIG. 6A, an external casing 3394 of the pen mouse is made of metallic material, copper material, plastic material or composite material, and includes a body casing part 3391 and a head casing part 3393. The first controlling unit 337 (not shown) is mounted on a main circuit board 3371 of the pen mouse. The main circuit board 3371 is connected with the sensing unit 331 via a connecting wire 338.

In FIG. 6B, in addition to the external casing 3394, the casing 339 further includes graduations 3395 and an opening 3397. The modulation structure 333 includes a sliding part 3331, a rotary joint 3333 and a rotating mechanism 3335. The sliding part 3331 protrudes out of the opening 3397, so that the sliding part 3331 is rotatable by the user. According to the graduations 3395, the user may position the sliding part 3331. By moving/rotating the sliding part 3331 along the opening 3397, the rotary joint 3333 and the rotating mechanism 3335 are simultaneously rotated. As the rotating mechanism 3335 is rotated, the sensing unit 331 is adjusted to a desired position or orientation.

The above embodiments are illustrated by adjusting the position of the sensing unit through the modulation structure. In some embodiments, a manual control element (not shown) may be disposed on the casing 339 of the pointing device 33 and connected with the modulation structure 333. An example of the manual control element includes but is not limited to a button or a knob. Through the manual control element, the modulation structure 333 is controlled to adjust the position of the sensing unit 331. It is to be noted that numerous modifications and alterations of the modulation structure 333 may be made while retaining the teachings of the invention. For example, the modulation structure 333 may be a track, a gear, a reel or another structure capable of driving movement of the sensing unit 311. In other words, any structure capable of moving or rotating the sensing unit 311 may be used as the modulation structure 333.

In the above embodiments, the position of the sensing unit 331 of the pointing device 33 is adjusted through the modulation structure 333. It is to be noted that numerous modifications and alterations of the way of communicating the pointing device and the display device may be made while retaining the teachings of the invention.

Furthermore, the pointing device 33 may have auto-adjusting function for individual user. The adjusting information, for example offset angle of the sensing unit 331, may be recorded in a memory unit (not shown) of the pointing device 33. The memory unit is electrically connected with the first controlling unit 337 for recording associated information. After the controlling method of the pointing device 33 of the present invention is implemented, the information associated with the optimal position of the sensing unit 331 will be recorded in the memory unit. Once the pointing device 33 is operated by the designated user, the sensing unit 331 can be adjusted to the desired position (e.g. the second position) through the modulation structure 333 according to the recorded information.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A pointing device cooperating with a display device showing a cursor moving in response to a movement of the pointing device, the pointing device comprising:
a casing;
a sensing unit disposed in the casing, arranged in a first position for sensing a first movement of the pointing device to acquire first movement information, and arranged in a second position for sensing the first movement of the pointing device to acquire second movement information; and
a modulation structure disposed on the casing and connected with the sensing unit for adjusting the sensing unit from the first position to the second position.

2. The pointing device according to claim 1 wherein the pointing device further comprises:
a transceiver unit in communication with the display device for transmitting the first movement information and the second movement information to the display device; and
a controlling unit in communication with the sensing unit and the transceiver unit for controlling the modulation structure to adjust the sensing unit to the second position.

3. The pointing device according to claim 2 wherein the modulation structure comprises:
a sliding part protrudes out of the casing; and
a rotating mechanism disposed within the casing, linked to the sliding part and in communication with the sensing unit, wherein when the sliding part is manipulated by a user, the rotating mechanism is rotated to drive the sensing unit from the first position to the second position.

4. The pointing device according to claim 3 wherein the modulation structure further comprises a rotary joint disposed within the casing and linked to the rotating mechanism, for driving the rotating mechanism to rotate in response to a control signal issued from the controlling unit.

5. The pointing device according to claim 2 wherein the modulation structure comprises a motor connected with the controlling unit and the sensing unit, for rotating or moving the sensing unit to the second position in response to a control signal issued from the controlling unit.

6. The pointing device according to claim 2 wherein the first movement information complies with a first user basis and the second movement information complies with a second user basis which is more consistent with a standard basis of the display device than the first user basis.

7. The pointing device according to claim 6, further comprising a memory unit in communication with the controlling unit for recording the second position.

8. The pointing device according to claim 1 wherein the first movement information complies with a first user basis and the second movement information complies with a second user basis which is more consistent with a standard basis of the display device than the first user basis.

9. The pointing device according to claim 1 wherein the casing is made of metallic material, copper material, plastic material or composite material.

10. The pointing device according to claim 1, further comprises a manual control element disposed on the casing and connected with the modulation structure, for controlling the modulation structure to adjust the sensing unit in response to users operation on the manual control element, the manual control element comprising a button or a knob.

11. The pointing device according to claim 1 wherein the modulation structure comprises a track, a gear or a reel to move or rotate the sensing unit.

12. The pointing device according to claim 1 wherein the pointing device is in communication with the display device by a wireless transmission technology or a wired transmission technology.

13. A display system, comprising:
the pointing device of claim 1; and
the display device in communication with the pointing device, for displaying the cursor moving along a first moving path corresponding to the first movement information, and displaying the cursor moving along a second moving path corresponding to the second movement information.

14. The display system according to claim 13 wherein a training program is executed in the display device to instruct the adjustment of the sensing unit of the pointing device.

15. A controlling method of a pointing device moving a cursor on a display device, comprising steps of:
sensing a first movement of the pointing device to acquire first movement information when a sensing unit of the pointing device is in a first position;
adjusting the sensing unit through a modulation structure of the pointing device to move the sensing unit from the first position to a second position; and
sensing the first movement of the pointing device when the sensing unit is in the second position to acquire second movement information.

16. The controlling method according to claim 15, further comprising steps of:
displaying the cursor moving along a first moving path corresponding to the first movement information; and
displaying the cursor moving along a second moving path corresponding to the second movement information.

17. The controlling method according to claim 15 wherein the first moving path complies with a first user basis and the first user basis is compared with a standard basis of the display to obtain adjusting information.

18. The controlling method according to claim 17 wherein the sensing unit is adjusted to the second position through the modulation structure according to the adjusting information, and the second moving path complies with a second user basis which is more consistent with the standard basis of the display device than the first user basis.

19. The controlling method according to claim 18 wherein the modulation structure is manually controlled or controlled by a controlling unit of the pointing device.

20. The controlling method according to claim 17, further comprising a step of recording the adjusting information in a memory unit of the pointing device.
